(19) United States
(12) Patent Application Publication
(10) Pub. No.: US 2009/0321693 A1
(43) Pub. Date: Dec. 31, 2009

(54) Red colored composition and color filter using the same

(75) Inventors: Satoshi Ohkuma, Tokyo (JP); Noriko Asahi, Tokyo (JP); Mie Shimizu, Tokyo (JP); Koichi Minato, Tokyo (JP)

Correspondence Address: STAAS & HALSEY LLP, SUITE 700, 1201 NEW YORK AVENUE, N.W., WASHINGTON, DC, 20005, US

(73) Assignee: TOPPAN PRINTING CO., LTD., Tokyo (JP)

(21) Appl. No.: 12/457,946

(22) Filed: Jun. 25, 2009

(30) Foreign Application Priority Data
Jun. 27, 2008 (JP) 2008-168711

(51) Int. Cl. F21V 9/00

(52) U.S. Cl. 252/582

(57) ABSTRACT

A red colored composition including a pigment, binder resin, monomer, photopolymerization initiator, and organic solvent, wherein the pigment contains a diketopyrrolopyrrol-based red pigment and has an average primary particle diameter of at most 40 nm, and the binder resin contains at least one thermosetting resin of 5 to 12% by weight based on solid content of the composition, the thermosetting resin having a weight-average molecular weight of 25,00 to 20,000.

### CROSS-REFERENCE TO RELATED APPLICATIONS

This application is based upon and claims the benefit of priority from prior Japanese Patent Application No. 2008-168711, filed Jun. 27, 2008, the entire contents of which are incorporated herein by reference.

### BACKGROUND OF THE INVENTION

1. Field of the Invention

The present invention relates to a red colored composition and a color filter for a liquid crystal display device using the same.

2. Description of the Related Art

In recent years, because of the thinness in wall thickness and the resultant advantages such as space-saving, lightweight properties, power-saving, etc., liquid crystal display devices are now rapidly propagated, especially as a display device for televisions. In the display device for televisions, it is required to enhance various display performance factors, such as the lightness and contrast. In a color filter, which is a member constituting the liquid crystal device, it is required to further to enhance the lightness and contrast.

Color Index Pigment Red 177, which is anthraquinone-based red pigment, has been used. This pigment can be fined by a mechanical treatment. Since the obtained fined pigment can be dispersed relatively easily in a solvent or resin solution and has a high affinity to the other material constituting the red pixel and soluble with each other, it does not cause any problems in forming a colored pixel and is useful to enhance a contrast (see JP-A 10-148712). This pigment, however, has a spectroscopic property in which there is an absorption peak around 600 nm, enhancement of the lightness is limited.

On the other hand, Color Index (=C.I.) Pigment Red 254, which is diketopyrrolopyrrol-based red pigment is frequently used in place of anthraquinone-based red pigment. Since this pigment has a transmission spectrum around 600 nm, the peak of which is nearer to a short wavelength side than that of the anthraquinone-based red pigment, it shows small absorption of red line in light from a backlight, and thus enabling to increase a lightness (see for example, JP-A 11-232516).

Diketopyrrolopyrrol-based red pigment can be easily fined by mechanical treatment. When a degree of fineness of diketopyrrolopyrrol-based red pigment is promoted, it becomes insoluble in solvent or resin solution due to its high cohesiveness, and its affinity for and compatibility with the other component constituting the red colored composition becomes low. As a result, the pigment has a low dispersion in the red colored composition. Therefore, it is difficult to enhance a contrast.

Recently, it has been tried to suppress an amount of the diketopyrrolopyrrol-based red pigment in the red colored composition by adding anthraquinone-based red pigment and azo-based red pigment to solve the above-described problems, and to decrease an average primary particle diameter of each pigment to obtain a red colored composition having a high transmittance and high contrast (see JP-A 2007-133131).

As described above, however, since the finely divided diketopyrrolopyrrol-based red pigment has a low dispersion in the red colored composition, the diketopyrrolopyrrol-based red pigment is precipitated on the surface of the colored layer formed by curing the red colored composition containing the diketopyrrolopyrrol-based red pigment in the post-baking step, even if the amount of the diketopyrrolopyrrol-based red pigment is suppressed. The precipitated crystal scatters light in liquid crystal layer and causes depolarization, thus lowering in contrast. Furthermore, the precipitated crystal is dissolved in liquid crystal to contaminate it, thus lowering reliability of liquid crystal. Therefore, there is a limit to enhancement of contrast due to fineness of the pigment. It is difficult to obtain the red colored layer of high contrast and high reliability.

### BRIEF SUMMARY OF THE INVENTION

An object of the present invention is to provide a red colored composition having a property of suppressing precipitation and crystallization of the pigment on the surface of a red colored layer formed of the red colored composition in the post baking step, high exposure sensitivity, good alkali developing property, and tendency capable of forming a pixel of a stable shape.

Another object of the present invention is to provide a color filter comprising a red pixel formed using the red colored composition, and method for the color filter.

According to a first aspect of the present invention, there is provided a red colored composition comprising a pigment, binder resin, monomer, photopolymerization initiator, and organic solvent, wherein the pigment contains a diketopyrrolopyrrol-based red pigment and has an average primary particle diameter of at most 40 nm, and the binder resin contains at least one thermosetting resin of 5 to 12% by weight based on solid content of the composition, the thermosetting resin having a weight-average molecular weight of 2,500 to 20,000.

According to a second aspect of the present invention, there is provided a color filter comprising a red pixel, a green pixel, and a blue pixel, wherein the red pixel is formed using the red colored composition described above.

According to a third aspect of the present invention, there is provided a method of manufacturing a color filter, comprising forming a film of the red colored composition described above, exposing to light, developing the exposed film of the red colored composition, and hardening the developed film to form a red pixel.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view schematically illustrating the color filter according to one embodiment of the present invention; and

FIG. 2 is a cross-sectional view schematically illustrating one example of a liquid crystal display device which is provided with a color filter of the present invention.

### DETAILED DESCRIPTION OF THE INVENTION

There will be explained various embodiments of the present invention.

A red colored composition according to a first aspect of the present invention comprises a pigment, binder resin, monomer, photopolymerization initiator, and organic solvent, wherein the pigment contains a diketopyrrolopyrrol-based red pigment and has an average primary particle diameter of at most 40 nm, and the binder resin contains at least one thermosetting resin of 5 to 12% by weight based on solid content of the composition, the thermosetting resin having a weight-average molecular weight of 2,500 to 20,000.

In the red colored composition according to a first aspect of the present invention, since the binder resin contain at least one thermosetting resin of 5 to 12% by weight based on solid content of the composition, and the thermosetting resin has a weight-average molecular weight of 2,500 to 20,000, even is the diketopyrrolopyrrol-based red pigment is finely divided, precipitation and crystallization of the pigment on the surface of the red colored layer are suppressed. It is possible, therefore, to obtain a red colored layer which has a high reliability and in which crystal precipitation of the pigment on the surface thereof in the post baking step is suppressed.

Further, since the red colored composition contains as a pigment the diketopyrrolopyrrol-based red pigment having an average primary particle diameter of at most 40 nm, it is possible to form a red colored layer having a high transmittance and high contrast.

As for the thermosetting resin, a resin containing 5-12% by weight of at least one melamine resin based on total solid content may preferably be used. The reason is that the melamine resin has a prominently high effect on suppressing crystal precipitation among other thermosetting resins.

The thermosetting resin includes a melamine compound obtained by reacting a melamine resin with acid anhydride, melamine compound containing a melamine resin and isocyanate group, or another melamine compound obtained by reacting said melamine resin with acid anhydride. Each of the melamine compounds may posses an acid value of solid content of at most 60 mg KOH/g.

Since photosensitivity is given to the melamine resin itself, the deteriorated photosensitivity and developing property can be recovered in the red colored composition according to the first aspect of the present invention.

In order to suppress the crystal precipitation of the diketopyrrolopyrrol-based red pigment, a little large amount of melamine resin can be added to the red colored composition. Even in this case, Exposing sensitivity can not be lowered and alkali development does not become unstable. Therefore, in the red colored composition according to the first aspect of the present embodiment, a red-colored pixel having a sharp and excellent shape property can be formed on the color filter.

The melamine resin explained above can be produced using a compound represented following formula (1).

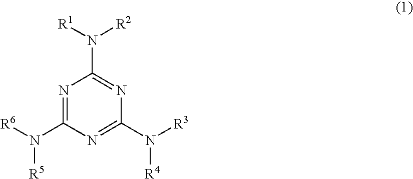

wherein R¹, R² and R³ are individually a hydrogen atom, methylol group, alkoxymethyl group or alkoxy n-butyl group; and R⁴, R⁵ and R⁶ are individually a methylol group, alkoxymethyl group or alkoxy n-butyl group.

In particular, C.I.Pigment 254 may be preferably employed as a diketopyrrolopyrrol-based red pigment.

The color filter according to the second aspect of the present invention includes a red pixel, a green pixel, and a blue pixel, wherein the red pixel is formed using the red colored composition described above.

In this color filter, chromaticity y is 0.30 to 0.40 and brightness Y value may be at least 23 in XYZ system of the red pixel when x is 0.64, which is measured using F10 light source, a contrast C(C=Lp/Lc) is at least 10,000. In this case, Lp is the luminance of light measured by means of a luminance meter as the light is passed through a laminated structure consisting of a pair of polarizing plates with a coated film of the red colored composition being sandwiched therebetween after a backlight is applied to one of the polarizing plates and permitted to emit from the other of the polarizing plates under a condition wherein axes of these polarizing plates are parallel with each other; and Lc is the luminance of light measured under the same conditions as described above except that axes of these polarizing plates are orthogonal to each other.

The red pixel constituting the color filter described above has excellent properties of lightness and contrast.

There will be described the red colored composition for color filter according to the first embodiment of the present invention.

The red colored composition for color filter according to the first embodiment of the present invention contains a pigment, binder resin, monomer, photopolymerization initiator, and organic solvent. The red colored composition may contain if necessary, a dispersion agent, sensitizer, and leveling agent. Further, the red colored composition contains a diketopyrrolopyrrol-based red pigment and if necessary, may further contain an anthraquinone-based red pigment and azo-based yellow pigment. The binder resin may contain at least one thermosetting resin.

In order to realize enhanced lightness and enhanced contrast of the liquid crystal display apparatus, the red colored composition for color filter according to the first embodiment of the present invention may contain a diketopyrrolopyrrol-based red pigment having an average primary particle diameter of 5 to 40 nm. Since the diketopyrrolopyrrol-based pigment has no absorption around 600 nm, it is advantageous to use it as a red pigment in order to improve transmittance. Further, when the diketopyrrolopyrrol-based pigment having an average primary particle diameter of at most 40 nm is used, a sufficient contrast can be obtained.

The average primary particle diameter of the pigment can be measured by photographing the pigment by making use of a transmission electron microscope. If the average primary particle diameter of the pigment is larger than 40 nm, lightness and contrast a color filter would be deteriorated. On the other hand, if the primary particle diameter of the pigment is smaller than 5 nm, it may become difficult to disperse the pigment in a solvent or resin solution and to secure the fluidity of the colored composition. As a result, it may become difficult to form a pixel itself.

In the red colored film formed by using the red composition according to the present embodiment, a contrast may be preferably at least 10,000, more preferably at least 12,000, when x is 0.64, which is measured using F10 light source. When a transmittance is improved and light leakage in dark display is reduced to realize a contrast of 10,000 or more, an excellent visibility can be obtained. However, when a contrast is less than 10,000, a visibility of the liquid crystal display device becomes poor.

The contrast C (C=Lp/Lc) can be determined by a method wherein the colored layer formed on a transparent substrate is sandwiched between two polarizing plates and a backlight is applied from one of the polarizing plates and the light is allowed to pass through the other of the polarizing plates and the luminance of light passing through the other polarizing plate is measured by means of a luminance meter, thereby measuring the luminance of light under a condition wherein the polarizing axes of these polarizing plates are disposed parallel with each other to determine the luminance of light (Lp) and also measuring the luminance of light under a condition wherein the polarizing axis of these polarizing plates are disposed so as to intersect orthogonally with each other to determine the luminance of light (Lc).

In the red colored composition for color filter according to the present embodiment, in order to balance between a lightness and hue, it is preferred that the chromaticity y of the red colored film formed of the red colored composition is controlled to 0.30 to 0.40 and lightness Y value is at least 23 in XYZ system of the red pixel when x is 0.64, which is measured using F10 light source. When the chromaticity y of the red colored film is less than 0.30, the transmittance of the red colored film becomes low, thus lowering the lightness. On the other hand, when the chromaticity y of the red colored film is larger than 0.40, a pixel hue shifts to yellowish color, and it is difficult to realize a display of high color reproducibility. Further, when the lightness Y is less than 23, it is not preferred since such a low lightness lowers the brightness of the liquid crystal display device. F10 light source is a typical fluorescent lamp of JIS standard and has a spectral distribution similar to that of a three-wavelength range emission type fluorescent lamp which is used as a backlight of a conventional liquid crystal display device.

The pigment used in the red colored composition of the present embodiment may contain anthraquinone-based red pigment and azo-based yellow pigment. As for the anthraquinone-based red pigment, it is preferable to employ C.I. Pigment Red 177 in order to secure excellent light resistance, heat resistance, transparency and tinting strength. As for the azo-based yellow pigment, it is preferable to employ C.I. Pigment Yellow 1, 3, 10, 12, 13, 14, 17, 55, 81, 83, 93, 94, 95, 97, 150, 154, 166, 167, 180. Above all, it is preferable to employ C.I. Pigment Yellow 150 in order to secure excellent light resistance, heat resistance, transparency and tinting strength. In the pigment used in the red colored composition of the present embodiment, the azo-based yellow pigment is used in order to condition colors.

The red colored composition for color filter of the present embodiment may be preferably formed of at most 60% by weight of anthraquinone-based red pigment and at most 30% by weight of the azo-based yellow pigment. More preferably, The red colored composition may be formed of at most 50% by weight of anthraquinone-based red pigment and at most 25% by weight of the azo-based yellow pigment, both based on the total weight of the pigments. If the content of the anthraquinone-based red pigment is larger than 60% by weight, it is difficult to obtain a sufficient lightness. Further, If the content of the azo-based red pigment is larger than 30% by weight, the pixel hue may be excessively shifted to a yellowish color, thus deteriorating the color reproducibility.

As described above, the finely divided diketopyrrolopyrrol-based red pigment is precipitated on the pixel during the post-baking step in forming pixel of the color filter. In particular, when the primary particle diameter of the pigment becomes 40 nm or less, the precipitation generates prominently. Therefore, it is difficult to realize a high contrast of the liquid crystal display device by using the diketopyrrolopyrrol-based red pigment.

The present inventors have considered this problem and have found that crystal precipitation is suppressed when the binder resin contains at least one kind of thermosetting resin. The crystal precipitation of the diketopyrrolopyrrol-based red pigment can be confirmed by observing the red colored layer during the post-baking step in forming pixel process by optical microscope.

Furthermore, a quantitative estimation of the crystal precipitation can be conducted by tracing change in a contrast depending on a temperature or time in baking of the colored layer obtained by coating a red colored composition on a glass substrate and hardening it. When crystals precipitates on the surface of the film, light scatters on the crystals to generate depolarization, thus lowering a contrast.

As for the thermosetting resin, it is possible to employ, for example, an epoxy resin, benzoguanamine resin, rosin-modified maleic resin, rosin-modified fumaric acid resin, melamine resin, urea resin, phenol resin, etc. Melamine resin can be preferably employed above all.

As for the melamine compound, monomer or polymer represented by the following general formula (1) and available in the market can be preferably employed. However, it is possible to use any melamine compounds having a thermosetting property. Therefore, any kind of known melamine compounds having a thermosetting property can be also employed. Following are examples of melamine compounds.

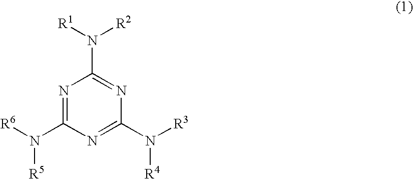

wherein R¹, R² and R³ are individually a hydrogen atom, methylol group, alkoxymethyl group or alkoxy n-butyl group; and R⁴, R⁵ and R⁶ are individually a methylol group, alkoxymethyl group or alkoxy n-butyl group. It is possible to employ a copolymer having a combination of two or more kinds of repeated units. Two or more kinds of homopolymers or copolymers may be co-used.

In addition to the compounds described above, it is also possible to employ a compound having a 1,3,5-triazine ring such as those set forth in JP-A 2001-166144. Further, the compounds represented by the following general formula (2) can be also preferably employed.

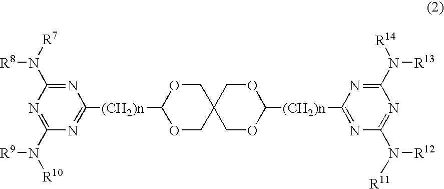

Wherein R⁷ through R¹⁴ are individually a hydrogen atom, alkyl group, aryl group or heterocyclic group. Among them, the hydrogen atom is especially preferable.

The melamine compound includes a melamine compound obtained by reacting a melamine resin with acid anhydride, melamine compound containing a melamine resin and isocyanate group, and another melamine compound obtained by reacting said melamine resin with acid anhydride. Each of the melamine compounds has a weight-average molecular weight of preferably at least 2,500 and an acid value of solid content of preferably at most 60 mg KOH/g. When a large amount of a conventional melamine resin or a melamine compound having a weight-average molecular weight of less than 2.500 is added, a sensitivity of the photosensitive resin composition deteriorates and exposure time for a sufficient curing is prolonged, thus lowering producibility.

When a large amount of the melamine resin or a melamine compound is added, alkali developing property of the photosensitive resin composition deteriorates, adjustment of developing time becomes difficult and the developing time is prolonged. In some cases, developing speed is too fast and the film may peel. A large amount of melamine resin or a melamine compound may prevent from exerting effects of suppressing crystal precipitation.

Upper limit of weight-average molecular weight of the melamine resin or a melamine compound is not limited. However, when the weight-average molecular weight of the melamine resin or a melamine compound exceeds 20,000, its solubility into an organic solvent and developing property with alkali solution deteriorate. Therefore, the upper limit of weight-average molecular weight of the melamine resin or a melamine compound may be 20,000.

When the red-colored composition contains the melamine compound having a photosensitivity imparted by isocyanate group, effects of the melamine compound can be exerted without troubleshoot such as deterioration of sensitivity, prolonged exposure time for curing, and lowering of producibility, which are caused by using the conventional melamine resin. When the photosensitive composition contains the melamine compound having a developing property imparted, effects of the thermosetting resin can be exerted without troubleshoot such as deterioration of alkali developing property, prolonged developing time due to uncontrolled developing time, or peeling of the film due to unduly fast developing speed.

When the thermosetting resin having a weight-average molecular weight of 2.500 or more, it is possible to obtain a photosensitive resin composition having an excellent photosensitivity, that is, a clear contrast between the exposed portion and unexposed portion, regenerating a mask shape, capable of forming a pattern with a sharp edge, and having a fine patterning property.

A content of the thermosetting resin is 5 to 12%, preferably 8 to 12% by weight based on total solid content of the red-colored composition. When a content of the thermosetting resin is less than 5% by weight based on total solid content of the red-colored composition, a sufficient thermosetting property is not be obtained. On the other hand, when a content of the thermosetting resin exceeds 12% by weight based on total solid content of the red-colored composition, the resin composition may lose a photosensitivity and it may make it difficult to form a colored layer by photo-setting.

As described above, when the melamine compound having a photosensitivity imparted by isocyanate group is contained in the red-colored composition, 5 to 12% by weight of the melamine compound can be used without loss of photosensitivity and an excellent thermosetting property, that is, effects of suppressing crystal precipitation may be exerted.

As for the diketopyrrolopyrrol-based red pigment, it is preferable to employ C.I. Pigment Orange 71, C.I. Pigment Red 254, 255, 264; for the anthraquinone-based red pigment. In particular, it is preferable to employ C.I. Pigment Red in order to secure excellent light resistance, transparency and tinting strength.

As for the means for controlling the average primary particle diameter of pigment, it is possible to employ a method wherein a pigment is mechanically pulverized, thereby controlling the diameter and shape of the primary particle (so-called attrition method); a method wherein a solution of pigment dissolved in a good solvent is introduced into a poor solvent, thereby precipitating a pigment having a desired primary particle diameter and a desired particle shape (so-called precipitation method); and a method wherein a pigment having a desired primary particle diameter and a desired particle shape is manufactured on the occasion of synthesizing the pigment (so-called synthetic precipitation method). Depending on the synthesizing method and chemical characteristics of the pigment to be employed, any suitable method may be optionally selected for each pigment. Following are explanations about the aforementioned methods.

The attrition method is a method wherein a pigment is mechanically kneaded together with a grinding agent, such as a water-soluble inorganic salt such as salt, and with a water-soluble organic solvent which does not dissolve the grinding agent, by making use of a ball mill, a sand mill or a kneader (hereinafter referred to as salt milling), after which the inorganic salt and the organic solvent are removed through water washing and dried to obtain a pigment having a desired specific surface area. However, since there is the possibility that crystal growth is caused to occur in the pigment due to the salt milling treatment, to prevent crystal growth in the salt milling treatment, it would be effective to incorporate a solid resin which can be partially dissolved by the aforementioned organic solvent and a pigment-dispersing agent.

With respect to the mixing ratio of the pigment and the inorganic salt, when the ratio of the inorganic salt is large, the fining efficiency of the pigment can be enhanced but the throughput of the pigment is caused to decrease, thereby deteriorating the productivity.

Because of this, it is generally preferable to confine the mixing ratio of the inorganic salt to 1-30 parts by weight, more preferably 2-20 parts by weight per one part by weight of the pigment. On the other hand, the water-soluble organic solvent is employed herein so as to make the pigment and the inorganic salt into a uniform agglomerate, thus the water-soluble organic solvent can be employed at a mixing ratio of 50 to 300 parts by weight per one part by weight of the pigment, though this depends on the mixing ratio of the pigment and the inorganic salt.

More specifically, the attrition method is performed as follows. Namely, a small amount of a water-soluble organic solvent is added as a wetting agent to a mixture comprising a pigment and a water-soluble inorganic salt and then vigorously kneaded by making use of a kneader, etc. The resultant mixture is then introduced into water and stirred by making use of a high-speed mixer to obtain a slurry. This slurry is then subjected to filtration, water washing and drying to obtain a granular pigment having a desired primary particle diameter.

The precipitating method is a method wherein a pigment is dissolved in a suitable kind of good solvent and then mixed with a poor solvent, thereby precipitating pigments having a desired primary particle diameter. According to this precipitating method, it is possible to control the size of the primary particle diameter by suitably selecting the kind and quantity of these solvents, the precipitation temperature, the precipitating rate, etc.

Since in general a pigment cannot be easily dissolved in a solvent, the solvents that can be employed are limited. Specific examples of the solvents that can be employed are strongly acidic solvents such as concentrated sulfuric acid, polyphosphoric acid, chlorosulfonic acid; and basic solvents such as liquid ammonia, a dimethyl formamide solution of sodium methylate, etc.

As a typical example of this precipitating method, there is known an acid pasting method wherein a pigment is dissolved in an acidic solvent to obtain a solution, which is then introduced into another solvent to thereby re-precipitate fine particles, thus obtaining a finely divided pigment. In this case, in viewpoint of manufacturing cost, a method of pouring a sulfuric acid solution into water is generally employed in the industry.

Although there are no particular limitations with respect to the concentration of the sulfuric acid, it is generally preferable to confine it to the range of 95 to 100% by weight. Although there are no particular limitations with respect to the mixing ratio of the sulfuric acid and the pigment, if the mixing ratio is too small, the viscosity of the resultant solution would become too high, thus making it difficult to easily handle the solution. On the contrary, if the mixing ratio is too large, the treatment efficiency of the pigment would be deteriorated. Therefore, the mixing ratio of sulfuric acid to the pigment is preferably confined to the range of 3-10 weight part based on one weight part of the pigment.

Incidentally, the pigment is not necessarily required to be completely dissolved in the solvent. The temperature on the occasion of dissolution is preferably confined to the range of 0-50° C. If the temperature is lower than 0° C., the sulfuric acid may freeze and, additionally, the solubility of the pigment will be decreased. On the other hand, if the temperature is higher than 50° C., a side reaction is more likely to occur.

The temperature of the water to be poured is preferably confined to the range of 1-60° C. If the temperature of the water is higher than 60° C., the water may boil due to the heat of dissolution on pouring water into the sulfuric acid, thus making the work very dangerous. On the other hand, if the temperature of the water is lower than 1° C., the water may freeze. The time for the pouring of water is preferably confined to 0.1 to 30 minutes based on one weight part of the pigment.

The control of the primary particle diameter of the pigment may be performed by a combination of methods consisting of the precipitating method, such as the acid pasting method, and the attrition method, such as the salt milling method. This combination method is more preferable in the respects that it can be performed while taking the degree of grinding into consideration and that the fluidity of the dispersed body can be suitably secured.

In order to prevent flocculation of the pigment in the course of controlling the primary particle diameter of the pigment during the salt milling or the acid pasting, a dispersing agent such as a coloring material derivative, a resin type pigment dispersing agent, or a surfactant as shown below can be additionally employed. Further, when the control of the primary particle diameter of pigment is performed in the presence of two or more kinds of pigments, it would become possible to obtain a stable dispersion of pigments even if the pigments are inherently difficult to disperse if treated individually.

The synthesizing precipitation method is a method for precipitating a pigment having a desired primary particle diameter concurrent with the synthesis of the pigment. Since filtration, which is a typical separation method, is difficult to perform unless pigment particles are flocculated into large secondary particles on taking up the finely divided pigment products from a solvent, this synthesizing precipitation method is generally applied to a pigment such as azo type pigments, which can be synthesized in an aqueous system where secondary flocculation can easily take place.

Further, as for the means for controlling the primary particle diameter of the pigments, it is also possible to employ a method wherein a pigment is dispersed for a long period of time by making use of a high-speed sand mill (so-called dry milling method for dry-milling a pigment), thereby making it possible to minimize the primary particle diameter of the pigment concurrently with the dispersion of the pigment.

The pigment carrier to be contained in the red colored composition for a color filter according to the present embodiment is employed for dispersing the pigment, and is formed of a binder resin, precursors thereof or a mixture thereof.

The binder resin to be employed herein preferably has a permeability of not less than 80%, more preferably not less than 95% in a total wavelength range of 400-700 nm of visible light.

As for specific examples of the binder resin other than above-mentioned thermosetting resin, it is possible to employ another thermosetting resin, thermoplastic resin, and active energy ray-sensitive resin. The precursor may be a monomer or an oligomer which is capable of creating a transparent resin through the curing thereof by the irradiation of active energy ray. The resins and precursor can be employed singly or in combination of two or more kinds thereof.

The pigment carrier can be employed at a ratio ranging from 30 to 700 parts by weight, more preferably 60 to 450 parts by weight based on 100 parts by weight of the pigments in the colored composition.

In a case where a mixture consisting of a binder resin and the precursor thereof are to be employed as a pigment carrier, the transparent resin can be employed at a ratio ranging from 20 to 400 parts by weight, more preferably 50 to 250 parts by weight based on 100 parts by weight of the pigments in the colored composition.

Further, the precursor of the binder resin can be employed at a ratio ranging from 10 to 300 parts by weight, more preferably 10 to 200 parts by weight based on 100 parts by weight of the pigments in the colored composition.

As for the thermoplastic resin, it is possible to employ, for example, a butyral resin, styrene-maleic acid copolymer, chlorinated polyethylene, chlorinated polypropylene, polyvinyl chloride, vinyl chloride-vinyl acetate copolymer, polyvinyl acetate, polyurethane resin, polyester resin, acrylic resin, alkyd resin, polystyrene, polyamide resin, rubber-based resin, cyclized rubber-based resin, celluloses, polybutadiene, polyethylene, polypropylene, polyethylene, polybutadiene, polyimide, etc.

As for the other thermosetting resin, it is possible to employ, for example, an epoxy resin, benzoguanamine resin, rosin-modified maleic resin, rosin-modified fumaric acid resin, urea resin, phenol resin, etc.

As for the active energy ray-setting resin, it is possible to employ resins having a linear macromolecule into which a photo-crosslinking group such as a (metha)acryloyl group, styryl group, etc. has been introduced through a reaction between a linear macromolecule having a reactive substituent group, such as hydroxyl group, carboxyl group, amino group, etc. and a (metha)acrylic compound having a reactive substituent group such as an isocyanate group, aldehyde group, epoxy group, etc. or cinnamic acid.

It is also possible to employ a linear macromolecule containing an acid anhydride, such as a styrene-maleic anhydride copolymer or α-olefin-maleic anhydride copolymer half-esterified with a (metha)acrylic compound having a hydroxyl group, such as hydroxyalkyl (metha)acrylate.

As for specific examples of the monomers and oligomers which are cured by irradiation of active energy ray to form the precursors of the transparent resin, they include various kinds of acrylic esters and methacrylic esters such as methyl (metha)acrylate, ethyl (metha)acrylate, 2-hydroxyethyl(metha)acrylate, 2-hydroxypropyl(metha)acrylate, cyclohexyl (metha) acrylate, β-carboxyethyl (metha)acrylate, diethyleneglycol (metha)acrylate, 1,6-hexajiol di(metha)acrylate, polyethyleneglycol di(metha)acrylate, tripropyleneglycol (metha)acrylate, trimethylolpropane tri(metha)acrylate, pentaerythritol tri(metha)acrylate, 1,6-hexanediol diglycidyl ether di(metha)acrylate, bisphenol A diglycidyl ether di(metha)acrylate, neopentylglycol diglycidyl ether di(metha)acrylate, dipentaerythritol hexa(metha)acrylate, tricyclodecanyl (metha)acrylate, ester acrylate, methylolmelamine (metha)acrylate, epoxy (metha)acrylate, urethane acrylate; (metha)acrylic acid; styrene; vinyl acetate; hydroxyethyl vinyl ether, ethyleneglycol divinyl ether, pentaerythritol trivinyl ether, (metha)acryl amide; N-hydroxymethyl (metha)acryl amide; N-vinyl formamido, acrylonitrile; etc. These compounds can be employed either singly or as a mixture of two or more kinds thereof.

In the red colored composition for color filter according to the present embodiment, if the colored composition is desired to be cured through the irradiation of ultraviolet rays, a photo-polymerization initiator may be added to the colored composition.

As for specific examples of the photo-polymerization initiator useful in this case, they include an acetophenone-based photo-polymerization initiator such as 4-phenoxy dichloroacetophenone, 4-t-butyl-dichloroacetophenone, diethoxyacetophenone, 1-(4-isopropylphenyl)-2-hydroxy-2-methylpropan-1-one, 1-hydroxycyclohexylphenyl ketone, 2-methyl-1-[4-(methylthio)phenyl]-2-morpholinopropane-1-one, 2-benzyl-2-diamino-1-(4-morpholinophenyl)-butan-1-one; a benzoin-based photo-polymerization initiator such as benzoin, benzoin methyl ether, benzoin ethyl ether, benzoin isopropyl ether, benzyldimethyl ketal, etc.; a benzophenone-based photo-polymerization initiator such as benzophenone, benzoylbenzoic acid, benzoylmethyl benzoate, 4-phenyl benzophenone, hydroxybenzophenone, acrylated benzophenone, 4-benzoyl-4′-methyldiphenyl sulfide, 3,3′,4,4′-tetra(t-butylperoxycarbonyl)benzophenone, etc.; a thioxanthone-based photo-polymerization initiator such as thioxanthone, 2-chlorothioxanthone, 2-methylthioxanthone, isopropylthioxanthone, 2,4-diisopropylthioxanthone, 2,4-diethylthioxanthone, etc.; a triazine-based photo-polymerization initiator such as 2,4,6-trichloro-s-triazine, 2-phenyl-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-piperonyl-4,6-bis(trichloromethyl)-s-triazine, 2,4-bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2,4-trichloromethyl-(piperonyl)-6-triazine, 2,4-trichloromethyl(4′-methoxystyryl)-6-triazine, etc.; an oxime ester-based photo-polymerization initiator such as 1,2-octane diol, 1-[4-(phenylthio)-2-(o-benzoyl oxime)), o-(acetyl)-N-(1-phenyl-2-oxo-2-(4′methoxy-naphtyl)ethylidene)hydroxylamine; a phosphine-based photo-polymerization initiator such as bis(2,4,6-trimethylbenzoyl)phenylphosphine oxide, 2,4,6-trimethylbenzoyl phenylphosphine oxide; a quinine-based photo-polymerization initiator such as 9,10-phenanthrenequinone, camphorquinone, ethylanthraquinone; a borate-based photo-polymerization initiator; a carbazole-based photo-polymerization initiator; an imidazole-based photo-polymerization initiator; titanocene-based photo-polymerization initiator, etc.

These photo-polymerization initiators can be employed at a ratio ranging from 5 to 200 parts by weight, more preferably 10 to 150 parts by weight based on 100 parts by weight of the pigments in the colored composition.

The aforementioned photo-polymerization initiators can be employed either singly or as a mixture of two or more kinds thereof. Further, these photo-polymerization initiators can be employed in combination with as a sensitizer, an amine-based compound such as triethanolamine, methyldiethanolamine, triisopropanolamine, 4-dimethylamino methylbenzoate, 4-dimethylamino ethylbenzoate, 4-dimethylamino isoamylbenzoate, 2-dimethylamino ethylbenzoate, 4-dimethylamino-2-ethylhexylbenzoate, N,N-dimethylparatoluidine, 4,4′-bis(dimethylamino)benzophenone, 4,4′-bis(dietylamino)benzophenone, 4,4′-bis(ethylmethylamino)benzophenone.

These sensitizers can be employed at a ratio ranging from 0.1 to 60 parts by weight based on 100 parts by weight of the photo-polymerization initiator.

The colored composition may further comprise a polyfunctional thiol which is capable of acting as a chain-transfer agent. As for this polyfunctional thiol, it is possible to employ a compound having two or more thiol groups. Specific examples of such a compound include hexane dithiol, decane dithiol, 1,4-butanediol bisthiopropionate, 1,4-butanediol bisthioglycolate, ethyleneglycol bisthioglycolate, ethyleneglycol bisthiopropionate, trimethylolpropane tristhioglycolate, trimethylolpropane tristhiopropionate, trimethylolpropane tris(3-mercaptobutylate), pentaerythritol tetrakisthioglycolate, pentaerythritol tetrakisthiopropionate, trimercaptopropionate tris(2-hydroxyethyl)isocyanulate, 1,4-dimethylmercaptobenzene, 2,4,6-trimercapto-s-triazine, 2-(N,N-dibutylamino)-4,6-dimercapto-s-triazine, etc. These polyfunctional thiols can be employed singly or in combination of two or more kinds.

The mixing ratio of these polyfunctional thiols is preferably confined within the range of 0.05 to 100 parts by weight, more preferably 0.1 to 60 parts by weight based on 100 parts by weight of the pigments in the colored composition.

The colored composition may further contain a solvent for enabling the pigments to be sufficiently dispersed in the pigment carrier and for enabling the colored composition to be coated on the surface of a transparent substrate such as a glass substrate, thereby making it possible to easily create a layer of a filter segment having a hardened film thickness of 0.2-5 μm. Specific examples of such a solvent include, for example, cyclohexanone, ethyl Cellosolve acetate, butyl Cellosolve acetate, 1-methoxy-2-propyl acetate, diethyleneglycol dimethyl ether, ethyl benzene, ethyleneglycol diethyl ether, xylene, ethyl Cellosolve, methyl-n amyl ketone, propyleneglycol monomethyl ether, toluene, methylethyl ketone, ethyl acetate, methanol, ethanol, isopropyl alcohol, butanol, isobutyl ketone, petroleum solvent, etc. These solvents may be employed singly or in combination of two or more kinds.

The mixing ratio of these solvents is preferably confined within the range of 800 to 4000 parts by weight, more preferably 1000 to 2500 parts by weight based on 100 parts by weight of the pigments in the colored composition.

The red-colored composition can be manufactured by finely dispersing one or more kinds of pigments in a pigment carrier by dispersing means such a triple roll mill, a twin-roll mill, a sand mill, a kneader, an attritor, etc. In order to conduct a sufficient dispersion, a dispersing agent such as a resin type pigment dispersing agent, a surfactant, a coloring material derivative, etc. can be employed.

The coloring material derivative not only functions as a dispersing agent, but also has effects in preventing the crystal growth or re-flocculation of pigments in a pixel. The coloring material derivative is formed of a compound comprising an organic pigment having a substituent group introduced therein. The organic pigment herein includes diketopyrropyrrol-based organic pigment, azo-based organic pigment such as azo compound, disazo compound, polyazo compound; phthalocyanine-based organic pigment; anthraquinone-based organic pigment; quinacridone-based organic pigment; dioxazine-based organic pigment; perinone-based organic pigment; perylene-based organic pigment; tioindigo-based organic pigment; isoindoline-based organic pigment; isoindolinone-based organic pigment; quinophthalone-based organic pigment; indanthrene-based organic pigment; and metal complex-based organic pigment.

The organic pigment constituting the coloring material derivative includes pale yellow compounds such as naphthalene compound and triazine compound which are generally not called pigments.

Following are examples of substituent groups.

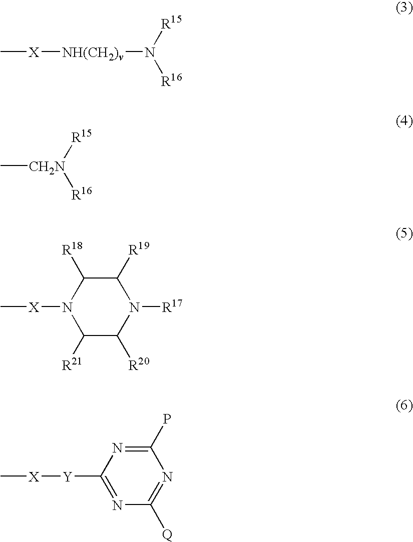

wherein X is —SO₂—, —CO—, —CH₂NHCOCH₂—, —CH₂—, or direst bond, v is a integer of 1 to 10, R¹⁵ and R¹⁶ are individually a substituted or unsubstituted alkyl group having 1-36 carbon atoms, a substituted or unsubstituted alkenyl group having 2-36 carbon atoms, a substituted or unsubstituted phenyl group, a substituted or unsubstituted heterocyclic residue which is an integral group of R¹⁵ and R¹⁶ further containing a nitrogen atom, oxygen atom and sulfur atom, R¹⁷ is a substituted or unsubstituted alkyl group having 1-36 carbon atoms, a substituted or unsubstituted alkenyl group having 2-36 carbon atoms, or a substituted or unsubstituted phenyl group, R¹⁸, R¹⁹, R²⁰, and R²¹ are individually a substituted or unsubstituted alkyl group having 1-36 carbon atoms, a substituted or unsubstituted alkenyl group having 2-36 carbon atoms, or a substituted or unsubstituted phenyl group, and Y is —NR²²-Z-NR²³— or direct bond, R²² and R²³ are individually a substituted or unsubstituted alkyl group having 1-36 carbon atoms, a substituted or unsubstituted alkenyl group having 2-36 carbon atoms, or a substituted or unsubstituted phenyl group, P is a substituent group represented by formula (7) or substituent group represented by formula (8), Q is a hydroxyl group, alkoxyl group, substituent group represented by formula (7) or substituent group represented by formula (8).

In formulas (7) and (8), X, R¹⁵-R²¹, and v are the same as in formulas (3) to (5).

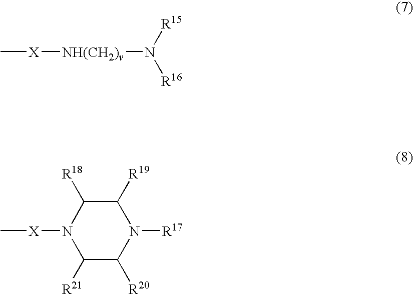

These coloring material derivatives may be employed singly or in combination of two or more kinds. The mixing ratio of the coloring material derivatives is preferably confined within the range of 5 to 40 parts by weight, more preferably 10 to 30 parts by weight based on 100 parts by weight of the pigments in the colored composition.

If the mixing ratio is less than 5 parts by weight, effects of suppressing crystal precipitation and flocculation may get smaller. If the mixing ratio exceeds 40 parts by weight, fluidity of the red-colored composition may not be kept.

The resin type pigment dispersing agent includes condensate of ricinoleic acid or 12-hydroxystearic acid, basic polymer compound, copolymer having an acid group, ester of fatty acid, aliphatic polyamine/polyester graft copolymer, and polyethylene/polypropylene addition polymer.

As for the surfactant, it is possible to employ an anionic surfactant such as polyoxyethylene alkylether sulfate, dodecylbenzene sodium sulfonate, alkali salts of styrene-acrylic acid copolymer, alkylnaphthaline sodium sulfonate, alkyldiphenyl ether sodium disulfonate, monoethanol amine lauryl sulfate, triethanol amine lauryl sulfate, ammonium lauryl sulfate, monoethanol amine stearate, sodium stearate, sodium lauryl sulfate, monoethanol amine of styrene-acrylic acid copolymer, polyoxyethylene alkylether phosphate, etc.; a nonionic surfactant such as polyoxyethylene oleyl ether, polyoxyethylene lauryl ether, polyoxyethylene nonylphenyl ether, polyoxyethylene alkylether phosphate, polyoxyethylene sorbitan monostearate, diethyleneglycol monolaurate, etc.; cationic surfactant such as alkyl quaternary ammonium salt and an ethylene oxide adduct thereof, etc.; and an amphoteric surfactant such as an alkyl betaine such as betaine alkyldimethyl aminoacetate, alkylimidazoline, etc. These surfactants can be employed singly or in combination of two or more kinds.

The red-colored composition for the color filter of the present embodiment may further contain a storage stabilizing agent for stabilizing the change of viscosity of the composition over time. As for specific examples of the storage stabilizing agent, they include, for example, quaternary ammonium chlorides such as benzyltrimethyl chloride, diethylhydroxy amine, etc.; organic acids such as lactic acid, oxalic acid, etc. and methyl ethers thereof; t-butyl pyrocatechol; organic phosphine such as tetraethyl phosphine, tetraphenyl phosphine, etc.; phosphite; etc.

The colored composition may further contain an adherence improver, such as a silane coupling agent, for the purpose of enhancing the adhesion to a substrate.

As for specific examples of the silane coupling agent, they include vinyl silanes such as vinyl tris(β-methoxyethoxy) silane, vinylethoxy silane, vinyltrimethoxy silane, etc.; (metha)acrylsilanes such as γ-methacryloxypropyltrimethoxy silane, etc.; epoxy silanes such as β-(3,4-epoxycyclohexyl)ethyltrimethoxy silane, β-(3,4-epoxycyclohexyl)methyltrimethoxy silane, β-(3,4-epoxycyclohexyl)ethyltriethoxy silane, β-(3,4-epoxycyclohexyl)methyltriethoxy silane, γ-glycidoxypropyl trimethoxy silane, γ-glycidoxypropyl triethoxy silane, etc.; amino silanes such as N-β(aminoethyl) γ-aminopropyl trimethoxy silane, N-β(aminoethyl) γ-aminopropyl triethoxy silane, N-β(aminoethyl) γ-aminopropyl methyldiethoxy silane, γ-aminopropyl triethoxy silane, γ-aminopropyl trimethoxy silane, N-phenyl-γ-aminopropyl trimethoxy silane, N-phenyl-γ-aminopropyl triethoxy silane, etc.; and thiosilanes such as γ-mercaptopropyl trimethoxy silane, γ-mercaptopropyl triethoxy silane, etc.

The red colored composition can be formulated as a gravure offset printing ink, a waterless offset printing ink, a silk screen printing ink, or a solvent developing type or alkaline developing type color resist. The color resist is formulated such that the pigment(s) is dispersed in a composition comprising a thermoplastic resin, thermosetting resin or photosensitive resin, a monomer, a photo-polymerization initiator and an organic solvent.

The pigment is preferably incorporated at a ratio of 5-70% by weight based on the quantity (100% by weight) of solids of the colored composition. More preferably, the pigment may be incorporated at a ratio of 20-50% by weight, the balance being substantially constituted by a resinous binder that can be provided by a pigment carrier.

The colored composition is preferably formulated such that bulky particles 5 μm or more in size, preferably, bulky particles 1 μm or more in size, more preferably, bulky particles 0.5 μm or more in size, most preferably, bulky particles 0.2 μm or more in size, as well as particles intermingled therein are completely removed from the composition by making use of any suitable means such as centrifugal separation, sintered filter, membrane filter, etc.

Next, there will be explained the color filter according to the second embodiment of the present invention.

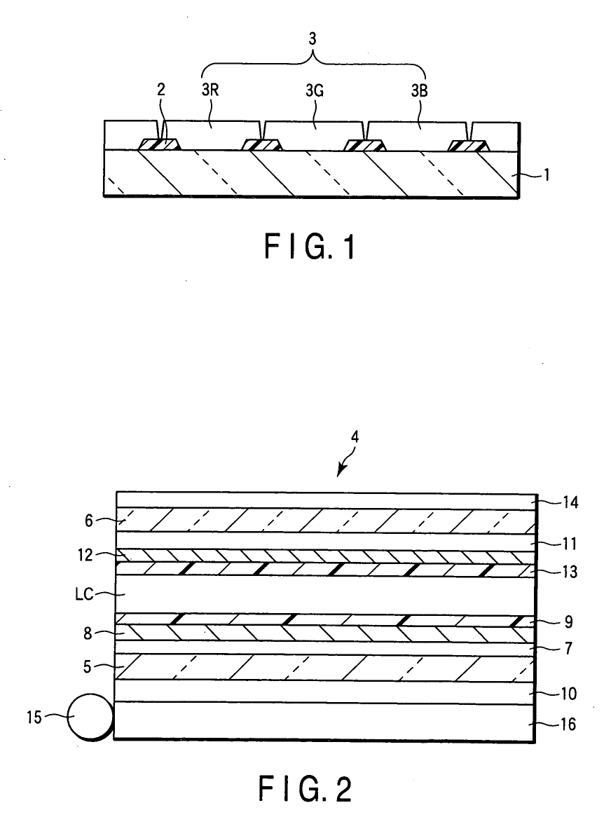

As shown in FIG. 1, the color filter according to the second embodiment of the present invention comprises a glass substrate 1, on which a black matrix 2 acting as a light-shielding layer, and colored pixels consisting of at least three colors, i.e. a red colored pixel 3 (R), a green colored pixel 3 (G) and a blue colored pixel 3 (B), are disposed.

The color filter according to the second embodiment of the present invention is provided, on a transparent substrate, with a red pixel, a green pixel and a blue pixel, all of which can be formed by means of printing or photolithography using each of colored compositions.

As for the transparent substrate, it is possible to employ a glass plate made of a material such as a soda-lime glass, low alkali borosilicate glass, alkaliless almino borosilicate glass, etc; and a resin plate made of a material such as polycarbonate, poly(methyl methacrylate), polyethylene terephthalate, etc. For the purpose of driving the liquid crystal after the fabrication of a liquid crystal panel, a transparent electrode consisting of a combination of metal oxides such as indium oxide, tin oxide, zinc oxide, antimony oxide may be formed on the surface of the glass plate or resin plate.

Since the patterning of these color segments by means of printing can be performed by simply repeating the printing and drying of a colored composition that has been prepared as various kinds of printing inks, the printing method is advantageous as a manufacturing method of a color filter in terms of manufacturing cost and mass production. Further, due to the recent developments in printing techniques, it is now possible to perform the printing of a very fine pattern which is excellent in dimensional precision as well as smoothness. In order to perform the printing, the ink is preferably formulated such that it cannot be dried or solidified on the surface of a printing plate or blanket. Furthermore, it is also important to control the fluidity of ink on the surface of the printing machine, so it may be advisable to adjust the ink viscosity by making use of a dispersant or an extender pigment.

When each of the colored pixels is to be formed by means of photolithography, a colored composition which has been formulated as a solvent developing type or alkaline developing type color resist is coated on the surface of the transparent substrate by any desired method of coating, such as spray coating, spin coating, slit coating, roll coating, etc., thereby forming a layer having a thickness (as dried) of 0.2-10 μm.

On the occasion of drying the coated layer, it may be performed by making use of a vacuum dryer, convection oven, IR oven, hot plate, etc. The layer thus dried as required is then subjected to exposure to ultraviolet rays through a mask having a predetermined pattern and disposed in or out of contact with this layer.

Subsequently, the resultant layer is dipped in a solvent or an alkaline developing solution or sprayed with a developing solution by means of a spraying machine, thereby removing the uncured portion, to obtain a desired pattern. Thereafter, the same procedures are repeated for other colors, thus manufacturing a color filter.

Further, for the purpose of promoting the polymerization of the color resist, heating may be applied to the coated resist. According to this photolithography method, it is possible to manufacture a color filter which is further excellent in precision as compared with that obtained from the aforementioned printing methods.

On the occasion of performing the development, an aqueous solution such as sodium carbonate, sodium hydroxide, etc. can be employed as an alkaline developing solution. It is also possible to employ an organic alkali such as dimethylbenzyl amine, triethanol amine, etc. Further, the developing solution may contain a defoaming agent or a surfactant. As for the developing treatment, it is possible to employ a shower developing method, a spray developing method, a dip developing method, a paddle developing method, etc.

Incidentally, in order to enhance the sensitivity to ultraviolet exposure, a water-soluble or alkali-soluble resin such as, for example, polyvinyl alcohol or a water-soluble acrylic resin may be coated on the color resist that has been coated and dried in advance, thereby forming a film which is capable of minimizing the effects of oxygen to obstruct the polymerization. Thereafter, the color resist is subjected to ultraviolet exposure.

The color filter according to the second embodiment of the present invention can be manufactured by means of an electrodeposition method or a transfer method other than the aforementioned methods. The electrodeposition method is a method which is featured in that, by taking advantage of a transparent conductive film formed on the surface of a transparent substrate, each of the color filter segments is electrodeposited on the transparent conductive film through the effects of electrophoresis of colloidal particles, thereby manufacturing the color filter.

On the other hand, the transfer method is a method which is featured in that a color filter layer is formed in advance on the surface of a releasable transfer base sheet and then this color filter layer is transferred onto a desired transparent substrate.

If a black matrix is formed on the transparent substrate or reflective substrate prior to forming of the colored pixels, it is possible to further improve a contrast of the liquid crystal display device. The black matrix may be formed of chromium film, chromium/chromium oxide multi-film, inorganic material film such as titanium nitride film, resin film containing a light shielding agent dispersed therein. The colored pixels may be formed on a TFT substrate including the transparent substrate or reflective substrate and a thin film transistor (TFT) formed thereon. If the colored pixels are formed on the TFT substrate, an aperture ratio of the liquid crystal display device can be increased, and a brightness of the liquid crystal display device can be improved. If necessary, an overcoat film, column-shaped spacer, transparent conductive film, alignment film, or the like may be formed on the color filter described above.

Next, a liquid crystal display device which is equipped with the color filter according to the second embodiment of the present invention will be explained.

FIG. 2 is a cross-sectional view schematically illustrating the liquid crystal display device which is provided with the color filter according to the second embodiment of the present invention. The liquid crystal display device 4 shown in FIG. 2 illustrates a typical example of a TFT drive type liquid crystal display device for use in a notebook-sized personal computer. This liquid crystal display device 4 is provided with a pair of transparent substrates 5 and 6, which are arranged face to face with a gap interposed therebetween. The gap between them is filled with a liquid crystal (LC). This LC is aligned in the VA (Vertical Alignment) alignment mode.

On the inner wall of the first transparent substrate 5, there is formed a TFT (thin film transistor) array 7. On this TFT array 7 is deposited a transparent electrode layer 8 formed of ITO, for example. On this transparent electrode layer 8 is further provided an alignment layer 9. Further, a polarizer (polarizing plate) 10, comprising an optical retardation film, is formed on the outer surface of the transparent substrate 5.

On the other hand, on the inner wall of the second transparent substrate 6, there is formed a color filter 11 according to one embodiment of the present invention. The red, green and blue filter segments constituting the color filter 11 are separated from each other by a black matrix (not shown). If required, a transparent protective film (not shown) may be formed so as to cover the color filter 11. Furthermore, a transparent electrode layer 12, formed of ITO for example, is formed on this protective film. An alignment layer 13 is deposited so as to cover the transparent electrode layer 12. Further, a polarizer 14 is formed on the outer surface of the transparent substrate 6. Incidentally, a backlight unit 16 equipped with a triple wavelength lamp 15 is disposed below the polarizer 10.

### EXAMPLES

Although specific examples of the present invention will be explained below, the present invention is not limited to these examples.

Incidentally, “part(s)” in the following examples and comparative examples means “weight part(s)”. Further, the symbols of pigments are indicated by a color index number. For example, “PR254” means “C.I. Pigment Red 254”, and “PY150” means “C.I. Pigment Yellow 150”.

### a) Measurement Methods

[Average Primary Particle Diameter of Pigment]

The primary particle diameter of pigments was measured by taking pictures of the pigments in view by making use of a transmission electron microscope (JEM-1200EX, manufactured by Japan Electron Co., Ltd.) and the measured values are averaged to obtain average primary particle diameter. If the particles are not spherical, particle diameter is determined by measuring major axis and minor axis of particles and calculating equation (major axis+minor axis)/2.

[Chromaticity and Contrast]

The chromaticity in a chromaticity diagram for an XYZ color specification system was measured by making use of a spectrophotometer (“OSP-200”; Olympus Co., Ltd.).

A polarizing plate was laminated on the opposite surfaces of the substrate having coated films formed thereon, and then the luminance of light (Lp) under the condition where these polarizing plates are disposed parallel with each other was compared with the luminance of light (Lc) under the condition where these polarizing plates are disposed to intersect orthogonally with each other to obtain the ratio of Lp/Lc, thereby calculating the contrast (C).

Then, by making use of a basic substrate having no colored pixel formed thereon, the contrast (CS) was measured, thereby enabling the ratio of C/CS to be used for the normalization. Incidentally, the luminance was measured by making use of a color luminance meter (“BM-5A”; Topcon Co., Ltd.) under the condition of a 2° viewing angle. As for the polarizing plate, “NPF-SEG1224DU” (Nitto Denko Co., Ltd.) was employed. Table 5 shows the contrast of each of the colored coated films.

The following Table 1 illustrates the coloring material derivatives employed in the following examples.

TABLE 1

| Pigment derivatives | Chemical structure |
|---|---|
| D-1 | 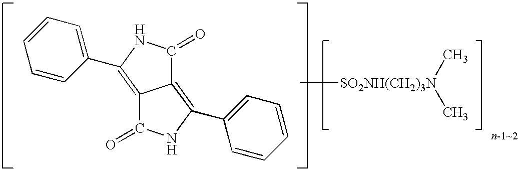 |
| D-2 | 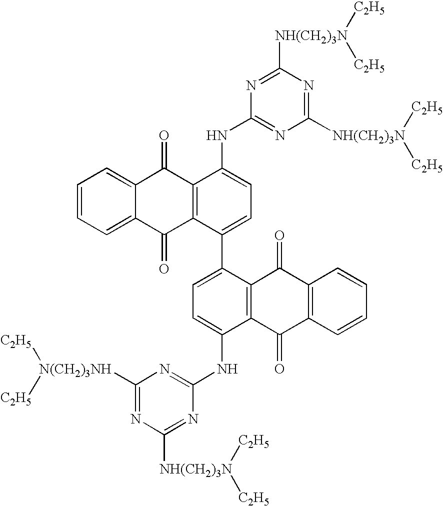 |
| D-3 | 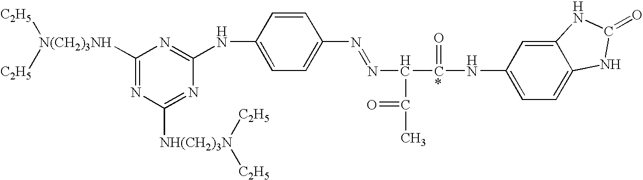 |

### b) Manufacture of Finely Divided Pigment

### Manufacturing Example 1

100 parts (based on weight, the same hereinafter) of a diketopyrrolopyrrol-based red pigment PR254 (Ciba Speciality Chemicals Co., Ltd. “IRGAFOR RED B-CF”), 10 parts of a coloring material derivative (D-1), 1000 parts of pulverized sodium chloride, and 120 parts of diethylene glycol were put into a 1 gallon stainless steel kneader (Inoue Seisakusho Co., Ltd.) and kneaded for 10 hours at a temperature of 60° C.

Then, the resultant mixture was introduced into 2000 parts of hot water and stirred for about one hour by means of a high-speed mixer while heating it at a temperature of about 80° C. to obtain a slurry. This slurry was then repeatedly subjected to filtration and water washing to remove sodium chloride and solvent, and was dried for 24 hours at a temperature of 80° C. to obtain a finely divided pigment (R-1). The primary particle diameter of the pigment thus obtained is 25 nm.

### Manufacturing Example 2

100 parts (based on weight, the same hereinafter) of a anthraquinone-based red pigment PR177 (Ciba Speciality Chemicals Co., Ltd. “CROMOPHTAL RED A2B”), 8 parts of a coloring material derivative (D-2), 700 parts of pulverized sodium chloride, and 180 parts of diethylene glycol were put into a 1 gallon stainless steel kneader (Inoue Seisakusho Co., Ltd.) and kneaded for 4 hours at a temperature of 70° C.

Then, the resultant mixture was introduced into 4000 parts of hot water and stirred for about one hour by means of a high-speed mixer while heating it at a temperature of about 80° C. to obtain a slurry. This slurry was then repeatedly subjected to filtration and water washing to remove sodium chloride and solvent, and was dried for 24 hours at a temperature of 80° C. to obtain a finely divided pigment (R-2). The primary particle diameter of the pigment thus obtained is 30 nm.

### c) Preparation of a Solution of Acrylic Resin

370 parts of cyclohexanone was put into a reaction vessel and heated at a temperature of 80° C. while introducing nitrogen gas into the reaction vessel, and then, while maintaining this temperature, a mixture of 20.0 parts of methacrylic acid, 10.0 part of methyl methacrylate, 55.0 part of n-butyl methacrylate, 15.0 part of hydroxyethyl methacrylate, and 4.0 part of 2,2-azobis-isobutyronitrile was added drop-wise to the cyclohexanone over one hour, thereby allowing a polymerization reaction to take place.

After finishing the addition of the aforementioned mixture, the reaction of this mixture was further allowed to take place for 3 hours at a temperature of 80° C. Thereafter, a solution consisting of 1.0 parts of azobis-isobutyronitrile, which was dissolved in 50 parts of cyclohexanone, was added to the reaction mixture and the reaction thereof was continued for one hour at a temperature of 80° C. to obtain an acrylic resin solution. The weight-average molecular weight of the obtained acrylic resin was about 40,000.

After being cooled down to room temperature, about 2 g of this resin solution was sampled out and thermally dried for 20 minutes at a temperature of 180° C. to measure the amount of nonvolatile matter. A suitable amount of cyclohexanone was added to the resin solution that had been synthesized in advance so as to make the ratio of the nonvolatile matter 20% by weight, thus preparing an acrylic resin solution.

### d) Preparation of Pigment Dispersion

A mixture having a composition shown in the following Table 2 was homogeneously stirred and then, by making use of zirconia beads having a diameter of 1 mm, the dispersion of the components of the composition was performed for 3 hours by means of Igar mill (mini-model M-250 MKII, Igar Japan Co. Ltd,.), and the resultant product was subjected to filtration by making use of a 5 μm filter to obtain a pigment dispersion of each color.

TABLE 2

| | | | Composition (part) | | | | | |
|---|---|---|---|---|---|---|---|---|
| Pigment | | Pigment | | | Pigment | Acrylic resin | | |
| dispersions | Pigment | derivatives | 1st pigment | 2nd pigment | derivatives | solution (P) | Cyclohexanone | Total |
| PR-1 | R-1 | D-1 | 10.8 | 0.0 | 1.2 | 40.0 | 48.0 | 100.0 |
| PR-2 | R-2 | D-2 | 10.8 | 0.0 | 1.2 | 40.0 | 48.0 | 100.0 |
| PR-3 | R-3 | D-1 | 11.2 | 0.0 | 0.8 | 40.0 | 48.0 | 100.0 |
| PR-4 | R-4 | D-2 | 11.2 | 0.0 | 0.8 | 40.0 | 48.0 | 100.0 |
| PY-1 | Y-1 | D-3 | 10.8 | 0.0 | 1.2 | 40.0 | 48.0 | 100.0 |

R-3: PR254; Chiba Speciality Chemicals Co., Ltd. “IRGAPHOR RED B-CF”; average primary particle diameter: 70 nm
R-4: PR177; Chiba Speciality Chemicals Co., Ltd. “CROMOPHTAL RED A2B”; average primary particle diameter: 80 nm
Y-1: PY150; Lanxess Co., Ltd. “E4GN-GT”; average primary particle diameter: 40 nm

### e) Manufacture of Melamine Compound (PM)

<Solution Substitution of Melamine Resin>

300 g of alkylated melamine resin/1-butanol solution (non-volatile content: 73.5 weight %, Trade name:Nicarack MX-750, manufactured by Nihon carbide industry, Co.,) was introduced into flask of 500 ml, and 1-butanol was removed from this solution using an evaporator. 781.8 g of cyclohexanone was added to the obtained alkylated melamine resin so that non-volatile content was 22% by weight, thus preparing a solution substituted melamine resin (M).

### Synthesis Example 1

### Melamine Compound (PM-1)

596.2 g of the solution substituted melamine resin A/cyclohexanone solution containing 22% by weight of non-volatile content, prepared as described above, and 6.3 g of butane tetracarboxylate (Trade name: Liquacid BT-100, manufactured by Sinnihonrika Co., Ltd.) were introduced into 5-necked reaction vessel, and allowed a reaction to take place for 24 hours at a temperature of 60° C. to obtain a product. Incidentally, it was confirmed that there is no absorption of acid anhydride group near 1780 cm⁻¹ in the product by infrared spectroscopic analysis.

After that, the product was diluted by cyclohexanone so that the non-volatile content of the product was 20% by weight to obtain a melamine compound solution (PM-1). Weight average molecular weight of the melamine compound (PM-1) was 6.700.

### Synthesis Example 2

### Melamine Compound (PM-2)

Melamine compound (PM-2) was produced by repeating the same procedures as described in Synthesis Example 1 except that the reaction time was 2 hours. Weight average molecular weight of the melamine compound (PM-2) was 1,800.

### Synthesis Example 3

### Melamine Compound (PM-3)

Melamine compound (PM-3) was produced by repeating the same procedures as described in Synthesis Example 1 except that the reaction time was 72 hours. Weight average molecular weight of the melamine compound (PM-3) was 22,000.

### f) Preparation of Red-Colored Composition

### Example 1

A mixture having a composition shown below was homogeneously stirred and then subjected to filtration through a 5 μm filter, thereby obtaining red-colored composition RR-1.

| | |
|---|---|
| Pigment dispersion (PR-1) | 50.0 part |
| Pigment dispersion (PR-1) | 2.5 part |
| Solution substituted melamine resin (M) | 5.0 part |
| Acrylic resin solution (P) | 5.0 part |
| Trimethylolpropane triacrylate | 4.5 part |
| (Osaka yukikagaku kogyo Co., Ltd., Biscoat #295) | |
| Photopolymerization-initiator | 0.2 part |
| (Irgar Cure 379; Ciba Speciality Chemicals Co., | |
| Ltd.) | |
| Sensitizer | 40.0 part |

### Examples 2-5, Comparative Example 1-6

Red-colored compositions RR-2 to RR-11 were produced by repeating the same procedures as described in Example 1 except that the pigment dispersion and resin were used shown in the following Table 3.

TABLE 3

| | | | | | | | | Comp. | Comp. | Comp. | Comp. | Comp. | Comp. | Comp. |
|---|---|---|---|---|---|---|---|---|---|---|---|---|---|---|
| | | Ex. 1 | Ex. 2 | Ex. 3 | Ex. 4 | Ex. 5 | Comp. Ex. 1 | Ex. 2 | Ex. 3 | Ex. 4 | Ex. 5 | Ex. 6 | Ex. 7 | Ex. 8 |
| Pigment dispersion | PR-1 | 50.0 | 50.0 | 22.5 | 50.0 | 50.0 | | | 50.0 | 50.0 | 50.0 | 50.0 | 50.0 | 50.0 |
| | PR-2 | 2.5 | 2.5 | 20.0 | 2.5 | 2.5 | | 45.8 | 2.5 | 2.5 | 2.5 | 2.5 | 2.5 | 2.5 |
| | PR-3 | | | | | | 50.0 | | | | | | | |
| | PR-4 | | | | | | 2.5 | | | | | | | |
| | PY-1 | | | 10.0 | | | | 15.3 | | | | | | |

| | | | | | | | | | | | | | |
|---|---|---|---|---|---|---|---|---|---|---|---|---|---|
| Melamine resin (M) | 7.2 | | | | 4.9 | | | | | | | | 11.0 |
| Melamine compound (PM-1) | | 7.8 | 7.8 | 12.0 | 5.5 | | | 3.2 | 1.6 | | | | |
| Melamine compound (PM-2) | | | | | | | | | | | 12.0 | | |
| Melamine compound (PM-3) | | | | | | | | | | | | 12.0 | |
| Acrylic resin (P) | 4.8 | 3.4 | 3.4 | | | 12.0 | 3.4 | 8.8 | 10.4 | 12.0 | | | 1.0 |
| Monomer | 3.2 | 3.2 | 3.2 | 3.0 | 3.2 | 3.2 | 3.2 | 3.2 | 3.2 | 3.2 | 3.2 | 3.2 | 3.2 |
| Photopolymerization- | 2.1 | 2.1 | 2.1 | 2.1 | 2.1 | 2.1 | 2.1 | 2.1 | 2.1 | 2.1 | 2.1 | 2.1 | 2.1 |
| initiator | | | | | | | | | | | | | |
| Sensitizer | 0.2 | 0.2 | 0.2 | 0.2 | 0.2 | 0.2 | 0.2 | 0.2 | 0.2 | 0.2 | 0.2 | 0.2 | 0.2 |
| Organic solvent | 40.0 | 40.8 | 40.8 | 40.2 | 41.6 | 40.0 | 40.0 | 40.0 | 40.0 | 40.0 | 40.0 | 40.0 | 40.0 |
| Total | 110.0 | 110.0 | 110.0 | 110.0 | 110.0 | 110.0 | 110.0 | 110.0 | 110.0 | 110.0 | 110.0 | 110.0 | 110.0 |

[Manufacture of the Coated Films of Various Colors

By means of spin coating, each of the color resists shown in above Table 3 was coated on the surface of a glass substrate and then pre-baked for 20 minutes in a clean oven at a temperature of 70° C. Then, after being cooled to room temperature, the substrate was exposed to ultraviolet rays by making use of an ultra-high pressure mercury lamp. Thereafter, the resultant substrate was subjected to spray development by making use of an aqueous solution of sodium carbonate heated up to 23° C., after which the resultant substrate was washed with ion-exchange water and air-dried. Subsequently, the resultant substrate was post-baked for 60 minutes in a clean oven at a temperature of 230° C., thereby forming a red-colored coated film. The film thickness of the dried coated film was 1.8 μm in all cases.

[Assessment of Crystal Precipitation]

Crystal precipitation of the red-colored coated films shown in Table 3 described above were assessed in the following manner.

The surface of the red-colored coated films produced as described above were observed by optical micrometer and assessed whether the crystal precipitation were caused. Thereafter, contrast Ci of the red-colored coated films were measured.

The red-colored coated films were baked for 60 minutes, 120 minutes, 180 minutes at a temperature of 230° C., and after each baking, observation by optical micrometer and measurement of contrast Cn(n=1-3) were conducted. Then, rates of change RCn from contrast Ci to contrast Cn were determined. The rates of change RCn were given by equation RCn=Cn/Ci (n=1-3).

Crystal precipitation of the red-colored coated films were assessed using RCn. The assessment ranking was as follows.

◯: RCn=0.90-1.00

Δ: RCn=0.80-0.90 (exclusive)

x: RCn less than 0.8

Crystal precipitation of the red-colored coated films were assessed by observation through optical micrometer. The assessment ranking was as follows.

◯: Crystal precipitation was not observed.

x: Crystal precipitation was not observed.

The results are illustrated in the following Table 4.

TABLE 4

| | | | Content of | | | | | | | | | |
|---|---|---|---|---|---|---|---|---|---|---|---|---|
| | | Thermo- | thermosetting | Crystal precipitation | | | | | | | | |
| | Pigment | setting | resin in | Baking time 60 min | | | Baking time 120 min | | | Baking time 180 min | | |
| | dispersion | resin | solid matter | RC1 | | Appearance | RC2 | | Appearance | RC3 | | Appearance |
| Ex. 1 | PR-1 PR-2 | M | 8.6% | 0.98 | ◯ | ◯ | 0.99 | ◯ | ◯ | 0.95 | ◯ | ◯ |
| Ex. 2 | PR-1 PR-2 | PM-1 | 8.5% | 1.00 | ◯ | ◯ | 0.98 | ◯ | ◯ | 0.99 | ◯ | ◯ |
| Ex. 3 | PR-1 PR-2 | PM-1 | 9.5% | 0.99 | ◯ | ◯ | 0.97 | ◯ | ◯ | 0.96 | ◯ | ◯ |
| | PY-1 | | | | | | | | | | | |
| Ex. 4 | PR-1 PR-2 | PM-1 | 13.0% | 1.00 | ◯ | ◯ | 0.98 | ◯ | ◯ | 0.99 | ◯ | ◯ |
| Ex. 5 | PR-1 PR-2 | M, PM-1 | 12.0% | 0.98 | ◯ | ◯ | 1.00 | ◯ | ◯ | 0.97 | ◯ | ◯ |
| Comp. | PR-3 PR-4 | — | 0.0% | 0.99 | ◯ | ◯ | 0.98 | ◯ | ◯ | 0.85 | Δ | X |
| Ex. 1 | | | | | | | | | | | | |
| Comp. | PR-2 PY-1 | — | 0.0% | 1.00 | ◯ | ◯ | 1.00 | ◯ | ◯ | 0.99 | ◯ | ◯ |
| Ex. 2 | | | | | | | | | | | | |
| Comp. | PR-1 PR-2 | PM-1 | 3.5% | 0.95 | ◯ | ◯ | 0.88 | Δ | X | 0.78 | X | X |
| Ex. 3 | | | | | | | | | | | | |
| Comp. | PR-1 PR-2 | PM-1 | 1.7% | 0.95 | ◯ | ◯ | 0.82 | Δ | X | 0.65 | X | X |
| Ex. 4 | | | | | | | | | | | | |
| Comp. | PR-1 PR-2 | — | 0.0% | 0.84 | Δ | X | 0.76 | X | X | 0.36 | X | X |
| Ex. 5 | | | | | | | | | | | | |
| Comp. | PR-1 PR-2 | PM-2 | 13.0% | 0.96 | ◯ | ◯ | 0.97 | ◯ | ◯ | 0.98 | ◯ | ◯ |
| Ex. 6 | | | | | | | | | | | | |
| Comp. | PR-1 PR-2 | PM-3 | 13.0% | 0.98 | ◯ | ◯ | 0.96 | ◯ | ◯ | 0.96 | ◯ | ◯ |
| Ex. 7 | | | | | | | | | | | | |
| Comp. | PR-1 PR-2 | M | 13.2% | 0.96 | ◯ | ◯ | 0.97 | ◯ | ◯ | 0.97 | ◯ | ◯ |
| Ex. 8 | | | | | | | | | | | | |

[Assessment of Sensitivity]

Each of the red colored compositions shown in Table 3 was assessed with respect to the sensitivity thereof.

Namely, first of all, the photosensitive coloring composition obtained as described above was coated, by means of a spin-coating method, on the surface of a glass substrate. Thereafter, the coated film was prebaked for 20 minutes at a temperature of 70° C. to form a coated film having a thickness of 2.3 μm. Then, the coated film was exposed by means of a proximity exposure system using a proximity aligner, to ultraviolet rays through a photomask with a fine pattern having a line width of 50 μm. The exposure dose was varied over eight levels, that is, 30 mJ/cm², 40 mJ/cm², 50 mJ/cm², 60 mJ/cm², 70 mJ/cm², 80 mJ/cm², 90 mJ/cm², 100 mJ/cm².

Then, by making use of a 1.25 wt % sodium carbonate solution, the coated film thus exposed was subjected to shower development, washing with water, and heating for 20 minutes at a temperature of 230° C., thereby finishing the patterning and obtaining a colored pixel.

Then, the film thickness of the filter segment thus obtained was divided by the film thickness (2.3 μm) of an unexposed/undeveloped region, thereby calculating the residual rate of the film. By making use of a coordinate system with the abscissa thereof representing the common logarithm of the exposure applied to the coated layer and the ordinate thereof representing the residual rate of the film after development, the sensitivity was plotted to obtain an exposure sensitivity curve. Based on the exposure sensitivity curve thus obtained, the initial exposure dose in the exposure sensitivity curve was defined as a rising exposure dose and the minimum exposure dose needed to attain a residual rate of 80% or more was defined as a saturated exposure dose, and, the sensitivity was assessed depending on the saturated exposure dose. The assessment ranking was as follows.

◯: The saturated exposure dose is 50 mJ/cm² or less.

Δ: The saturated exposure dose is 50 mJ/cm² (ecclusive) to 100 mJ/cm².

x: The saturated exposure dose is more than 100 mJ/cm².

The results are illustrated in the following Table 5.

[Assessment of Patterning Property]

Each of the red colored compositions shown in Table 3 was assessed with respect to the patterning property thereof.

Namely, first of all, the photosensitive coloring composition obtained as described above was coated, by means of a spin-coating method, on the surface of a glass substrate. Thereafter, the coated film was prebaked for 15 minutes at a temperature of 70° C. to form a coated film having a thickness of 2.3 μm. Then, the coated film was exposed by means of a proximity exposure system using a proximity aligner, to ultraviolet rays through a photomask with a fine pattern having a line width of 6-20 μm. The exposure dose was the saturated exposure dose described above.

Then, by making use of a 1.25 wt % sodium carbonate solution, the coated film thus exposed was subjected to shower development, and washing with water. Developing was carried out for a time sufficient to remove the un exposed portion of the coated film.

Thereafter, the film was heated for 20 minutes at a temperature of 230° C., thereby obtaining a sample.

The results are illustrated in the following Table 5.

TABLE 5

| | | | Content of | | | | | | |
|---|---|---|---|---|---|---|---|---|---|
| | | | Thermosetting | | | | | | |
| | Pigment | Thermosetting | resin in | Chromaticity | | | Contrast | | Patterning |
| | dispersion | resin | solid matter | Y | x | y | ratio Ci | Sensitivity | property |
| Ex. 1 | PR-1 PR-2 | M | 8.6% | 23.7 | 0.640 | 0.338 | 13000 | Δ | Δ |
| Ex. 2 | PR-1 PR-2 | PM | 8.5% | 23.9 | 0.640 | 0.338 | 13000 | ◯ | ◯ |
| Ex. 3 | PR-1 PR-2 | PM | 9.5% | 23.7 | 0.640 | 0.339 | 13000 | ◯ | ◯ |
| | PY-1 | | | | | | | | |
| Ex. 4 | PR-1 PR-2 | PM | 13.0% | 23.7 | 0.640 | 0.339 | 13000 | ◯ | ◯ |
| Ex. 5 | PR-1 PR-2 | M, PM | 12.0% | 23.7 | 0.640 | 0.339 | 13000 | Δ | ◯ |
| Comp. | PR-3 PR-4 | — | 0.0% | 23.7 | 0.640 | 0.338 | 5000 | ◯ | ◯ |
| Ex. 1 | | | | | | | | | |
| Comp. | PR-2 PY-1 | — | 0.0% | 21.3 | 0.640 | 0.336 | 16000 | ◯ | ◯ |
| Ex. 2 | | | | | | | | | |
| Comp. | PR-1 PR-2 | PM | 3.5% | 23.7 | 0.640 | 0.337 | 13000 | ◯ | ◯ |
| Ex. 3 | | | | | | | | | |
| Comp. | PR-1 PR-2 | PM | 1.7% | 23.9 | 0.640 | 0.336 | 12000 | ◯ | ◯ |
| Ex. 4 | | | | | | | | | |
| Comp. | PR-1 PR-2 | — | 0.0% | 23.7 | 0.640 | 0.336 | 13000 | ◯ | ◯ |
| Ex. 5 | | | | | | | | | |
| Comp. | PR-1 PR-2 | PM-2 | 13.0% | 23.7 | 0.640 | 0.336 | 13000 | X | X |
| Ex. 6 | | | | | | | | | |
| Comp. | PR-1 PR-2 | PM-3 | 13.0% | 23.7 | 0.640 | 0.336 | 13000 | ◯ | ◯ |
| Ex. 7 | | | | | | | | | |
| Comp. | PR-1 PR-2 | M | 13.2% | 23.9 | 0.640 | 0.338 | 12000 | X | X |
| Ex. 8 | | | | | | | | | |

It can be seen from Tables 4 and 5 above that since the red colored compositions obtained in Examples 1 through 5 contains a diketopyrrolopyrrol-based red pigment having an average primary particle diameter of at most 40 nm, and a binder resin containing thermosetting resin of 5 to 12% by weight based on solid content of the composition, having a weight-average molecular weight of 2,500 to 20,000, these red colored composition have a property of suppressing crystal precipitation, and excellent properties of chromaticity, contrast, sensitivity, and patterning. In particular, the red colored compositions, which were obtained in Examples 2 to 4 and contain melamine compound having a high molecular weight as a thermosetting resin, exhibit excellent sensitivity and patterning property.

On the other hand, the red colored compositions obtained in Comparative Example 1 contains a diketopyrrolopyrrol-based red pigment having an average primary particle diameter of more than 40 nm (70 nm, 80 nm) has a poor contrast. Further, the red colored compositions obtained in Comparative Example 2 containing only the other red pigment than a diketopyrrolopyrrol-based red pigment has a low lightness Y as 21.3.

Furthermore, the red colored compositions obtained in Comparative Examples 3 and 4 containing a thermosetting resin of less than 5% (3.5%, 1.7%) by weight based on solid content of the composition, and in Comparative Example 5 not containing thermosetting resin has a poor property of suppressing crystal precipitation.

The red colored compositions obtained in Comparative Example 6 containing a thermosetting resin of more than 12% (13.0%) by weight based on solid content of the composition, and in Comparative Example 8 containing a thermosetting resin having a weight-average molecular weight of less than 2,500 (1,800), exhibit poor sensitivity and patterning property.

Incidentally, the red colored compositions obtained in Comparative Example 7 containing a thermosetting resin having a weight-average molecular weight of more than 20,000 (22,000), has a property of suppressing crystal precipitation, and excellent properties of chromaticity, contrast, sensitivity, and patterning, but, a poor developing property which necessitates impractically a long time for development.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A red colored composition comprising a pigment, binder resin, monomer, photopolymerization initiator, and organic solvent, wherein said pigment contains a diketopyrrolopyrrol-based red pigment and has an average primary particle diameter of at most 40 nm, and said binder resin contains at least one thermosetting resin of 5 to 12% by weight based on solid content of the composition, said thermosetting resin having a weight-average molecular weight of 2,500 to 20,000.

2. The red colored composition according to claim 1, wherein said thermosetting resin contains a melamine resin ranging 5 to 12% by weight based on total solid content of the composition.

3. The red colored composition according to claim 1, wherein said thermosetting resin contains one selected from the group consisting of a melamine compound obtained by reacting a melamine resin with acid anhydride, melamine compound containing a melamine resin and isocyanate group, and another melamine compound obtained by reacting said melamine resin with acid anhydride, each of said melamine resin and melamine compounds has an acid value of solid content of at most 60 mg KOH/g.

4. The red colored composition according to claim 3, wherein said melamine resin or melamine compound is one produced using a compound represented following formula (1). 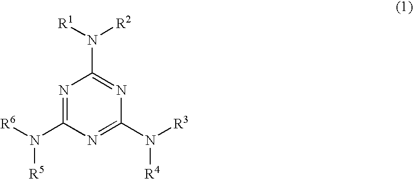
wherein R¹, R² and R³ are individually a hydrogen atom, methylol group, alkoxymethyl group or alkoxy n-butyl group; and R⁴, R⁵ and R⁶ are individually a methylol group, alkoxymethyl group or alkoxy n-butyl group.

5. The red colored composition according to claim 1, wherein the diketopyrrolopyrrol-based red pigment is Color Index Pigment red 254.

6. A color filter comprising a red pixel, a green pixel, and a blue pixel, wherein the red pixel is formed using the red colored composition recited in claim 1.

7. The color filter according to claim 6, wherein chromaticity y is 0.30 to 0.40 and brightness Y value is at least 23 in XYZ system of the red pixel when x is 0.64, which is measured using F10 light source, a contrast C represented from the following equation is at least 10,000,
C=Lp/Lc
wherein Lp is the luminance of light measured by means of a luminance meter as the light is passed through a laminated structure consisting of a pair of polarizing plates with a coated film of the red colored composition being sandwiched therebetween after a backlight is applied to one of the polarizing plates and permitted to emit from the other of the polarizing plates under a condition wherein axes of these polarizing plates are parallel with each other; and Lc is the luminance of light measured under the same conditions as described above except that axes of these polarizing plates are orthogonal to each other.

8. A method of manufacturing a color filter, comprising forming a film of the red colored composition recited in claim 1, exposing to light, developing the exposed film of the red colored composition, and hardening the developed film to form a red pixel.
